(19) United States
(12) Patent Application Publication
(10) Pub. No.: US 2011/0106442 A1
(43) Pub. Date: May 5, 2011

(54) COLLISION AVOIDANCE SYSTEM AND METHOD

(75) Inventors: Uday Babulal DESAI, Mumbai (IN); Shabbir Nomanbhai Merchant, Mumbai (IN); Suresh Sivaraman, Kottayam (IN); Mohit Agarwal, Bikaner (IN)

(73) Assignee: INDIAN INSTITUTE OF TECHNOLOGY BOMBAY, Mumbai (IN)

(21) Appl. No.: 12/648,069

(22) Filed: Dec. 28, 2009

(30) Foreign Application Priority Data
Oct. 30, 2009 (IN) 2516/MUM/2009

(51) Int. Cl. G08G 1/16; G01C 21/26; G01S 3/02

(52) U.S. Cl. 701/208; 701/301; 342/455

(57) ABSTRACT

Systems and methods for collision avoidance. The systems and methods include a global positioning system (GPS) device, motion sensors, and a geographic information system (GIS) device.

### CROSS-REFERENCE TO RELATED APPLICATIONS

The present application claims the benefit of Indian Patent Application No. 2516/MUM/2009, filed Oct. 30, 2009, which is hereby incorporated by reference in its entirety.

### BACKGROUND

Conventional vehicle collision warning systems use either the standard global positioning system (GPS) or differential global positioning system (DGPS) signal to locate and track vehicles. Initially, the standard GPS system was thought to be sufficient. Due to the military's concern about the possibility of enemy forces using the globally-available GPS signals to guide their own weapon systems, however, the standard GPS signal was intentionally degraded by offsetting the clock signal by a random amount, equivalent to about 100 meters of distance. This technique, known as “Selective Availability”, or SA for short, seriously degraded the usefulness of the GPS signal for nonmilitary users. SA, however, was discontinued in the early 1990's.

Prior to discontinuing SA, the size of the intentional degradation of the standard GPS signal proved to be a problem for civilian users who relied upon ground-based radio navigation systems. In the early to mid 1980s, a number of non-military agencies developed a solution to the degradation “problem.” The offset to the standard GPS signal was relatively fixed in any one area. Therefore, if the local offset was known, a correction signal can be broadcast to local users.

The DGPS was developed to correct for the offset. The DGPS system includes a series of base stations, typically located near large population centers. The DGPS system provides a clear improvement over the standard GPS system, however, the accuracy varies with distance from the local broadcasting station. Current low cost GPS systems have a typical error of a few meters (due to clouds and atmospheric interference). DGPS improves the accuracy to 10 cm or less.

Conventional vehicle collision warning systems do not predict driver behaviour at turns and curved roads since the future vehicle positions are predicted using only the present vehicle dynamics. Additionally, conventional vehicle collision warning systems are prone to false warnings in crowded places or may compromise the collision detection capability at high speeds due to the use of static vulnerability region around the vehicle used to check for collisions.

### BRIEF DESCRIPTION OF THE FIGURES

FIG. 1 is a schematic illustration of the results of a conventional collision avoidance system.

FIG. 2 is a schematic illustration of the results of a collision avoidance system according to an embodiment.

FIG. 3 is a plot illustrating simulated results of an embodiment.

FIG. 4 is a schematic diagram of an embodiment.

FIG. 5 is a flow diagram of an embodiment of a method.

FIG. 6 is a flow diagram of another embodiment of a method.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

An embodiment relates to a system comprising a global positioning system (GPS) device; at least one motion sensor; a geographic information system (GIS) device; and a measurement device, wherein the measurement device obtains data from the GPS device, the GIS device, and the at least one motion sensor to determine a position of a vehicle containing the GPS device and the at least one motion sensor. In one aspect, the motion sensor is a speedometer or an accelerometer. In another aspect, the system is configured to provide collision warning and/or collision avoidance.

In another aspect, the measurement device comprises at least one of a Fuzzy Logic, Kalman Filter, Adaptive Neural Network Measurement device, Genetic Algorithm, Particle Measurement device or Swarm Measurement device. In another aspect, the measurement device estimates the state of a linear dynamic system from a series of noisy measurements. In another aspect, the system further comprises a plurality of vehicles having a global position system device, at least one motion sensor, and a measurement device. In another aspect, the system further comprises a vehicle to vehicle communications system.

In another aspect, further comprises a differential global positioning system device (DGPS). In another aspect, further comprises a second measurement device. In another aspect, the geographic information system device comprises a map of the location of the vehicle. In another aspect, the measurement device is configured to use the map to make one or more future predictions of the position and/or motion of the vehicle.

An embodiment relates to a method of providing collision warning and/or collision avoidance comprising: obtaining data from a global positioning system (GPS) device, geographic information system (GIS) device, and at least one motion sensor; and determining a position of a vehicle containing the GPS device, the GIS device, and the at least one motion sensor. In one aspect, determining a position comprises using one or more of a Fuzzy Logic, Kalman Filter, Adaptive Neural Network Measurement device, Genetic Algorithm, Particle Measurement device or Swarm Measurement device. In another aspect, the method further comprises determining a region of vulnerability around the vehicle.

In another aspect, the method further comprises communicating with other vehicles. In another aspect, the method, further comprises slowing down at least one of a plurality of vehicles. In another aspect, the method further comprises issuing a warning to a driver of the vehicle. In another aspect, determining the position of a vehicle comprises using a differential global positioning system. In another aspect, determining the position of a vehicle comprises using a map of the location of the vehicle. In another aspect, the method further comprises determining an estimated future position of the vehicle based on present GPS, motion, and GIS data.

Embodiments of the collision warning system use algorithms for collision detection, such as a Kalman Filter, to predict vehicle positions in the future. Other algorithms that may be used include Fuzzy Logic, Adaptive Neural Network Filters, Genetic Algorithms, Particle Filter or Swarm Filters. Indeed, any algorithm which can be used to filter and predict future positions of the vehicle may be used. In some embodiments, predictions are made up to 10 seconds in the future. Further, using geographic information system (GIS) maps, the environment of the vehicle may be perceived. Road lane information, for example, may be extracted. Using the environmental information, the vehicle's predicted positions may be adjusted. For example, the typical behavior of a driver at turns (e.g., slowing down) may be factored into the adjustment.

In some embodiments, the collision detection algorithm may generate a “vulnerability region” around the vehicle for improved collision detection capability and reduction of false warnings. A “vulnerability region” is an imaginary region extended around the vehicle which may be a function of the speed of the vehicle. Typically, the greater the speed of the vehicle, the larger the size of the vulnerability region.

In some embodiments, “data fusion” is used to calculate future vehicle positions. “Data fusion” means the use of different types of data for the future position determination. For example, GPS signals give the present position of a vehicle. Motion sensors, on the other hand, provide information about the motion of the vehicle. Motion sensors include, but are not limited to, speedometers and accelerometers. In an example use of data fusion, the future position of a vehicle is estimated based on its current position, speed, and acceleration. In an example embodiment, GPS and GDPS signals generally are refreshed every second (1 Hz frequency). Motion sensors, however, may be sampled more frequently. In some embodiments, the motions sensors are sampled at a frequency of 10 Hz. In these embodiments, data fusion may be calculated at a 10 Hz frequency.

Other embodiments include vehicle-to-vehicle (V2V) communication. An example embodiment includes a plurality of vehicles in which the vehicles have collision detection systems that can communicate with the collision detection systems in the other vehicles. The V2V communication typically provides a more robust means of communicating GPS/DGPS data. This is because even if one of the systems is having difficulty receiving a GPS/DGPS signal, it may still receive GPS/DGPS data from one of the other vehicles via V2V communication. For correcting positional errors in one embodiment, only the DGPS correction factor is communicated using V2V. The GPS data is received individually in each vehicle directly from the GPS satellites using a GPS receiver. The GPS positional data is generally different for each vehicle.

Parameters in an active vehicle collision warning system generally include: (a) vehicle localization, (b) environment perception, and (c) analysis risk of collision and warning issuance. Based on the method of performing these operations, active vehicular safety systems can be classified as autonomous systems or collaborative safety systems. Autonomous systems rely on the onboard sensors, like RADAR, CCTV, etc. to sense their environment and detect vehicle collisions. These systems use Line-Of-Sight (LOS) for their operation and can suffer from the problem of blind spots. Also, since the onboard unit performs all the operations of identifying vehicles in the vicinity of the subject vehicle and then determines the possibility of collisions, the onboard unit requires high end processing.

In a collaborative active safety system, vehicles identify their location using GPS or any other triangulation method. This vehicular positional information is exchanged between the vehicles through inter-vehicle communication. With the positional information of all vehicles in its vicinity, each vehicle analyzes the possibility of collisions and warnings may be issued accordingly. Since most of the processing is typically distributed, each vehicle's onboard unit can be a less expensive, lower power processor compared to the Autonomous systems.

In a collaborative active safety system, collision risk analysis is performed by either considering the trajectories of all vehicles in the vicinity of the subject vehicle and/or by predicting future vehicle positions using filters like Fuzzy Logic, Kalman Filter, Adaptive Neural Network Filter, Genetic Algorithm, Particle Filter or Swarm Filter. The possibility of collision is typically checked with each vehicle in the neighborhood of the subject vehicle for each predicted position. Warnings may be issued to the driver either visually on an onboard display, or by an audible alarm.

### Examples

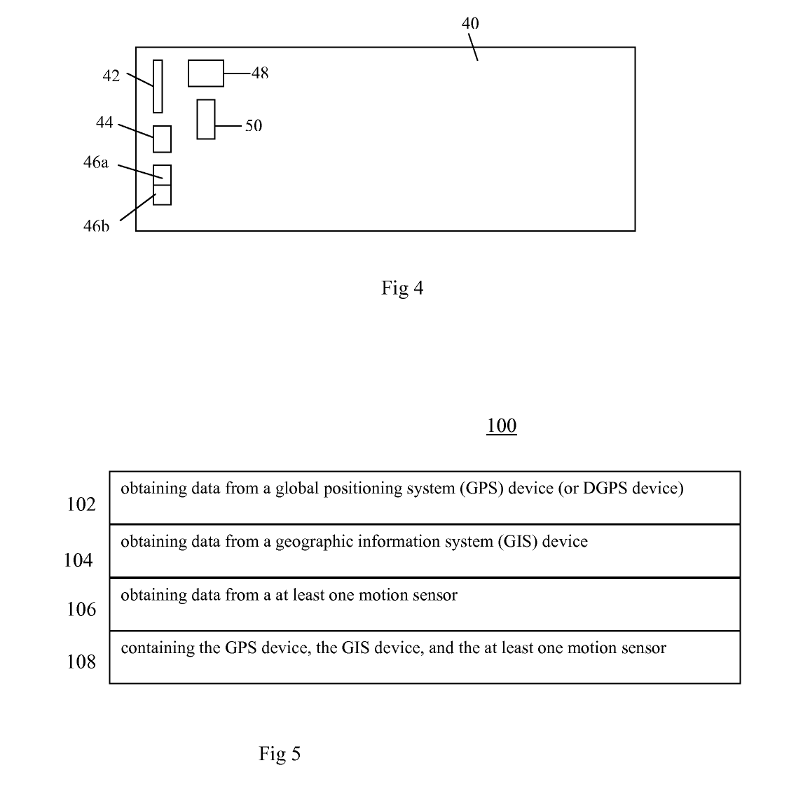

A schematic illustration of an embodiment is illustrated in FIG. 4 In this embodiment, a vehicle 40 includes a GPS/DGPS device 42, at least one motion sensor 44, a GIS device 50 and a measurement device 46a (and optionally a second measurement device 46b). The vehicle 40 also includes a vehicle communications system 48. The onboard GPS/DGPS device 42 can provide the vehicle position once every second to the measurement device 46a. The one second interval, however, is an example interval, other time intervals may be used. Example motion sensors include an onboard speedometer and 2-axis accelerometer. In one aspect, an onboard speedometer and a 2-axis accelerometer provide the speed and acceleration of the vehicle once every 0.1 second. Alternatively, an onboard speedometer and a 3-axis accelerometer may be used. Further, as with the onboard GPS/DGPS device, the onboard speedometer and accelerometer can be configured to provide data at rates other than at intervals of 0.1 second.

In an embodiment, the data from GPS/DGPS device, speedometer and accelerometer, received at different frequencies, are fused using a multi-frequency-measurement Kalman Filter to generate vehicle positions at 0.1 second intervals. The data fusing/position calculation is performed by the measurement device. The measurement device may be, for example, a specially programmed processor. The measurement device may be a separate device. In an alternative embodiment, the measurement device is incorporated into the GPS/DGPS device. For example, the processor of the GPS/DGPS device may include software or hardware performing steps and functions which allows it to perform the function of the measurement device.

The Kalman filter has two distinct phases: Predict and Update. The predict phase uses the state estimate from the previous timestep to produce an estimate of the state at the current timestep. This predicted state estimate is also known as the a priori state estimate because, although it is an estimate of the state at the current timestep, it does not include observation information from the current timestep. In the update phase, the current a priori prediction is combined with current observation information to refine the state estimate. This improved estimate is termed the a posteriori state estimate. In other embodiments, the Kalman Filter, may be replaced with Fuzzy Logic, Adaptive Neural Network Measurement device, Genetic Algorithm, Particle Measurement device or Swarm Measurement device.

### A.1 Kalman Filter Model for Filtering Heading

The equations of an example embodiment of a Kalman Filter used to filter the Heading are set forth below:

### A.1.1 Measurement Update Equations

x(k|k)=x(k|k−1)+K_{f}(k)[y(k)−Hx(k|k−1)], x(0|−1)=y(0) A.1.1.1

Rₑ(k)=R+HP(k|k−1)H^{T} A.1.1.2

K_{f}(k)=P(k|k−1)H^{T}Rₑ(k)⁻¹ A.1.1.3

P(k|k)=[I−K_{f}(k)H]P(k|k−1) P(0|−1)=10I,I=3×3 identity matrix A.1.1.4

### A.1.2 Time Update Equations

x(k+1|k)=Fx(k|k)

P(k+1|k)=FP(k|k)F^{T}+Q A.1.2.2

Where, state vector
x=[Heading 1^{st} derivative of Heading 2^{nd} derivative of Heading]^{T} measurement vector
   y=[Heading]

$$F = \begin{matrix}1 & T & ( 1 \text{/} 2 ) {T}^{2} \\ 0 & 1 & T \\ 0 & 0 & 1\end{matrix} \qquad A .1 .2 .3$$

and

h(x)=[1 0 0] A.1.2.4

### A.2 Kalman Filter Model for Filtering Position

An example embodiment of the Kalman filter model used to filter the vehicle position using the transformed measurements are given below:

### A.2.1 Measurement Update Equations

x(k|k)=x(k|k−1)+K_{f}(k)[y(k)−Hx(k|k−1)], x(0|−1)=y(0) A.2.1.1

Rₑ(k)=R+HP(k|k−1)H^{T} A.2.1.2

K_{f}(k)=P(k|k−1)H^{T}Rₑ(k)⁻¹ A.2.1.3

P(k|k)=[I−K_{f}(k)H]P(k|k−1) P(0|−1)=10I,I=6×6 identity matrix A.2.1.4

### A.2.2 Time Update Equations

x(k+1|k)=Fx(k|k) A.2.2.1

P(k+1|k)=FP(k|k)F^{T}+Q A.2.2.2

where, state vector

$$x = \begin{matrix}{X}^{′} ( vehicle position ) \\ {Y}^{′} ( vehicle position ) \\ {v}_{x} ( velocity ) \\ {v}_{y} ( velocity ) \\ {a}_{x} ( acceleration ) \\ {a}_{y} ( acceleration )\end{matrix} \qquad A .2 .2 .3$$

measurement vector

$$\begin{matrix}y = \begin{matrix}{X}^{′} ( vehicle position ) \\ {Y}^{′} ( vehicle position ) \\ {v}_{x} ( velocity ) \\ {v}_{y} ( velocity ) \\ {a}_{x} ( acceleration ) \\ {a}_{y} ( acceleration )\end{matrix} & A .2 .2 .4 \\ F = \vert \begin{matrix}1 & 0 & T & 0 & ( 1 \text{/} 2 ) {T}^{2} & 0 \\ 0 & 1 & 0 & T & 0 & ( 1 \text{/} 2 ) {T}^{2} \\ 0 & 0 & 1 & 0 & T & 0 \\ 0 & 0 & 0 & 1 & 0 & T \\ 0 & 0 & 0 & 0 & 1 & 0 \\ 0 & 0 & 0 & 0 & 0 & 1\end{matrix} \vert \\ and & A .2 .2 .5 \\ h ( x ) = \vert \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} \vert & A .2 .2 .6\end{matrix}$$

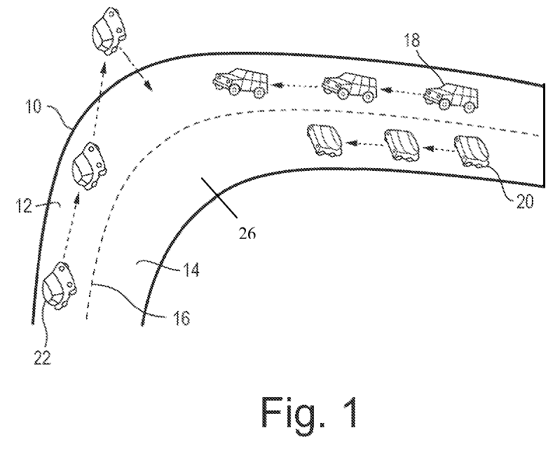

In an embodiment, a first estimation of the vehicle position, speed and heading (direction of motion) may be calculated for the next ten seconds (a 10 second interval) using Kalman Filter prediction equations. This first prediction is shown in FIG. 1. In alternative aspects, the first estimate may be calculated for shorter or longer times than 10 seconds. These first estimated vehicle positions are based on the present vehicle dynamics. For more accurate predictions then possible with only using present vehicle dynamics at curved roads, the predicted positions may be further processed as explained below.

Predicting the behavior of a vehicle at a turn even before the driver starts maneuvering the turn could be a challenge. With advances in Geographic Information System (GIS), GIS maps for road lanes are easily available. Using these maps of road lanes, the future vehicle position at turns and curved roads can be predicted ten seconds in future with appreciable accuracy even before the driver actually starts the turn. As discussed in more detail below, a Kalman Filter in combination with a GIS map can be used to adjust the predicted future location of a vehicle entering a turn or driving on a winding road more accurately than systems that do not use GIS maps and Kalman Filters.

In an example embodiment, the average response time for a driver to respond to a warning and stop the vehicle in the event of a probable collision is presumed to be around three to five seconds (the average response time as determined by experiment). In order to safely slow down the speed of the vehicle and take necessary action to prevent a collision, based on the above response time for drivers, the driver should be given a warning of approximately eight to ten seconds in advance. In an example embodiment, the system is designed to give warnings ten seconds in advance. In an example embodiment, predictions of vehicle location and improvement of accuracy of the predictions were performed in the following steps:
Using the current vehicle dynamics, ten future positions were predicted using Kalman Time Update equations described above (A.2.2.1-A.2.2.6).
The predicted positions were perpendicularly projected onto the road lane.
Using the projected points, a set of pseudo-measurements were generated.
The pseudo-measurements along with the current vehicle dynamics, were used to recalculate the vehicle dynamics ten seconds in future using Kalman Time Update equations and Kalman Measurement Update equations.
The predicted vehicle dynamics were used to assess the risk of collision.

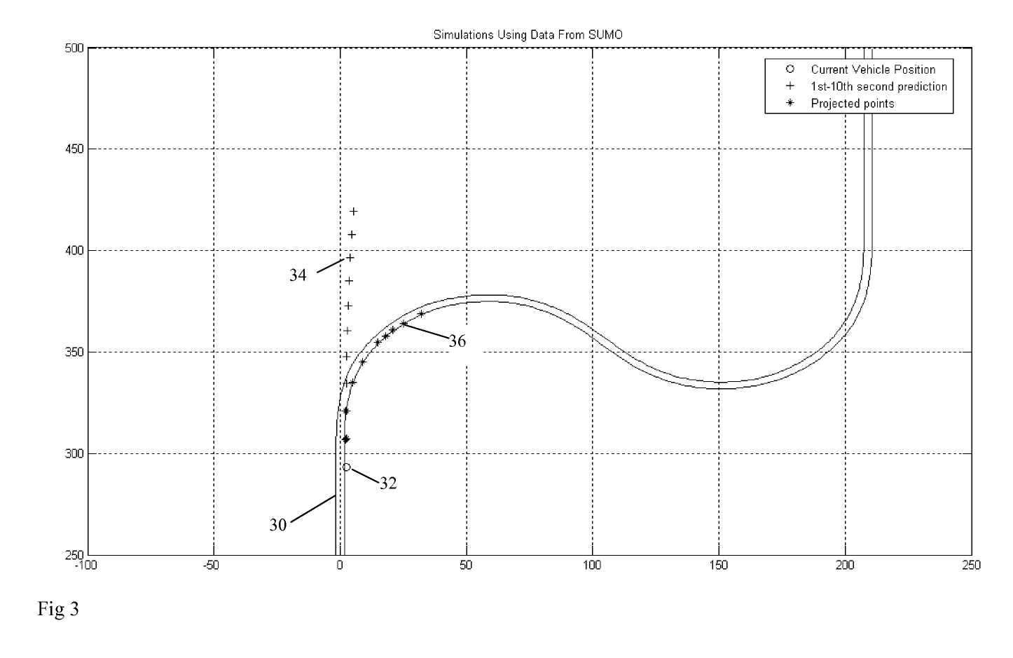

The Kalman Time Update equations (A1.2.1-A1.2.4) were applied on the state vector, which reflects the current vehicle dynamics. The time update equations were again applied on the resulting state vector and this iteration performed ten times to get ten future vehicle positions. The initial predictions using only dynamic data 34 based on the current location 32 of the vehicle are illustrated with “+” symbols in FIG. 3. The predicted positions using a Kalman Filter according to an embodiment are projected onto the road lane 30 are illustrated with “star” symbols 36. While maneuvering a turn, a driver may reduce the forward speed of the vehicle and may negotiate the turn at a reduced speed. This behavior can be seen in the projected points. If the turn had a sharper bend, the spacing between the projections would be even lesser, indicating that the vehicle has reduced the speed to a greater extent to negotiate the turn, which is exactly what a driver may do at a sharp turn. Hence this method of amending the future predictions mimics driver behavior and provides a practical solution to collision detection at turns and curved roads. In the illustrated simulation, a curved road was generated to be used for the road lane information. The same road was used as input for the SUMO traffic simulator. For a practical demonstration, the IIT Bombay Lake Side road in Mumbai, India was chosen and the road lane information was collected and stored a-priori.

In an embodiment, a GIS map of the area in which the vehicle is currently situated is downloaded on the fly and stored in the onboard unit. The download may be pushed to the collision warning system or accomplished automatically, that is, without prompting from the user. Alternatively, the user of the collision warning system can manually request a GIS map. The vehicle's environment is then perceived using the GIS map. The road lane information or road layout of the area may be extracted. The layout may include, for example curves, merges, splits, and even the number of lanes. This road lane information may be used to amend the predicted vehicle positions in a constrained manner. For example, the behavior of a typical driver entering turns and/or driving on curved roads may be used to modify the predicted position of a vehicle entering a turn or driving on a curved road.

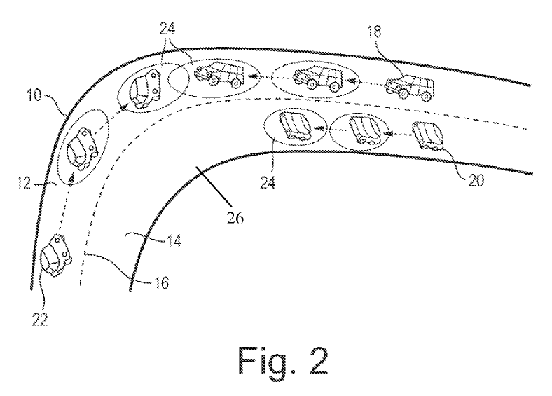

FIG. 1 illustrates collision prediction without road lane information while FIG. 2 illustrates an example embodiment using a Kalman filter and a GIS map of a vehicle entering a curve on a road. In the conventional method (FIG. 1), a first vehicle 18 and a second vehicle 20 are traveling side by side in a first direction in a first lane 12 and a second lane 14, respectively, of a two lane road 10. Traveling in a second, opposite direction in the first lane 12 is a third car 22. The first two cars are heading toward a curve 26 in the two lane road 10 but are relatively far from the curve 26. The third car 22, in contrast, is entering the curve 26. Because the first two cars are relatively far from the curve 26, their projected future positions (illustrated with icons at the head of an arrow) for two future position are accurately on the road. The situation is different, however, for the third car 22. Because current vehicle dynamics alone are used, only the first projection for the third vehicle 22 is accurate. The second projection of the third vehicle incorrectly shows the third vehicle 22 traveling in a straight line through the curve 26 and off the two lane road 10.

FIG. 2 illustrates an embodiment using a GIS map and Kalman Filter. Because the first and second vehicles 18 and 20 are relatively far from curve 26, their predicted future positions are essentially the same as illustrated in FIG. 1. In contrast to the conventional method, the vehicle positions predicted in this embodiment may be projected onto the road at an angle to the original direction of motion. Further, the spacing between each projected point may be inversely proportional to the degree of turn of the road. This implies that if the vehicle has to negotiate a sharp turn (like a U turn), the driver would slow down the vehicle to a greater extent when compared to driving on a road with a lesser curve. This is illustrated in the future projected positions of third car 22. Specifically, the second projected future position is in the first lane 12 of the two lane road 10 at an angle to and is closer to the first projected future position relative to the conventional method illustrated in FIG. 1. Hence, these projected points more closely mimic driver behaviour at turns than the conventional method. Additionally, vulnerability regions 24 may be projected around each vehicle 18, 20, 22 to provide a safety margin around each vehicle and help prevent a collision.

In addition to determining the position at distinct times in the future, embodiments may also determine vehicle dynamics at these points in the future. To generate the vehicle dynamics at these projected points, the velocity and acceleration for each projected position are mathematically calculated and a pseudo-measurement is generated. These pseudo-measurements may be used in a second Kalman Filter to filter the predicted positions of the vehicle to give future vehicle positions, speed and heading which even more closely mimics driver behaviour at turns and curved roads as shown in FIG. 2. On multi-lane roads, the road lane used for refining the predictions may be chosen based on the current and past vehicle position and data from accelerometers.

In another embodiment, the future vehicle positions of the subject vehicle are broadcast to neighbouring vehicles. Broadcasting may be accomplished, for example, by using Dedicated Short Range Communication (DSRC) or Vehicle-to-Vehicle (V2V) communication using IEEE 802.11p standard. Other methods of broadcasting and/or standards may also be used. In one embodiment, every vehicle in the vicinity of the subject vehicle also broadcasts its own present and future positions.

By listening to the transmissions by other vehicles, each vehicle can generate a map of its environment with the help of the road lane information. Each participating vehicle in the vicinity of the subject vehicle may be plotted on this map. Using the speed and heading, an ellipse may generated around each predicted position of each vehicle as a region of vulnerability. In one embodiment, the minor axis of the ellipse is proportional to the width of the vehicle and the major axis of the ellipse is a function of the speed of the vehicle. The function may be, but is not limited to logarithmic. In one embodiment, the major axis points in the direction of motion (vehicle heading). By adaptively modifying the shape of the vulnerability region, the collision detection capability may be improved at higher speeds and chances of false warning in crowded areas lowered.

The intersection of the vulnerability region of the subject vehicle with the vulnerability region of another vehicle in both space and time indicates the possibility of a collision. Depending on the time to collision, different levels of warning are issued to the driver. In one embodiment, a warning light is turned on. If collision is more imminent, the warning light may flash. Optionally, an audio warning with increasing levels of volume may be used. In still other embodiments, a combination of light and audio may be used.

In another embodiment, a GPS correction factor (using DGPS) is broadcasted to all vehicles using V2V communication from road-side units spread out in the area. Using this correction, the GPS device may provide vehicle positions with sub-meter accuracy. These accurate vehicle positions along with the road lane information may give an indication if the vehicle is veering off the lane and going dangerously close to the edge of the road. This can happen, for example, as a result of lack of concentration of the driver due to drowsiness, inattention, etc. A warning may then be issued to the driver to correct the course of the vehicle. In one aspect, a travel log comprising the position data and/or the issued warnings may be recorded in a manner similar to a black box on an aircraft. Further, in another aspect, warnings may be broadcast to local authorities to alert police/fire/rescue officials of an impending emergency. Indeed, behavioral software may be included which can detect erratic driving associated with drowsiness or intoxication.

In one embodiment, if the driver does not respond to a critical warning, the collision avoidance system communicates between the vehicles involved in the predicted collision. Optionally, if a reduction in speed in one of the vehicles can prevent the collision, that vehicle may be automatically slowed down If, however, slowing one vehicle is insufficient, the brakes in both the vehicles may be activated and the collision avoided.

Driver behaviour at road features such as turns, where the driver would reduce the speed of the vehicle depending on the angle of the turn, is well captured by the fine tuned future vehicle positions. This makes the predicted future positions of the vehicle come close to the true positions, resulting in a collision warning system that is more dependable. This is in contrast to conventional systems in which the advantage of road lane information is not being used to improve the prediction capabilities of the collision warning system.

By adaptively changing the shape of the vulnerability region around each vehicle, the collision detection capability at high speeds is increased. Further, false warnings in slow moving crowded traffic conditions are reduced. Conventional systems use the same uncertainty ellipse for all vehicle positions and for all speeds. The conventional system is therefore prone to false warnings and also compromises the collision detection capability at high speeds.

In some embodiments, predictions of the vehicle positions in future, the vehicle dynamics are recalculated using the road lane information, pseudo-measurement and a second Kalman Filter at each prediction. This improves the vehicle collision detection capability of the proposed system. In contrast, conventional systems use only the present vehicle dynamics to predict the vehicle position and check for collisions. This can lead to false warnings or failure of the system in detecting a collision at turns and curved roads. In another embodiment, vehicles may have additional sensors such as ultrasonic, laser, or radar to detect surrounding vehicles. That is, in alternative embodiments, aspects of both autonomous and collaborative active safety systems can be combined. Such embodiments may be used, for example, in bumper-to-bumper traffic to provide additional warning of close vehicles.

Use of a multi-frequency-measurement Kalman Filter combines the advantages of a GPS receiver which gives accurate position at 1 Hz and the advantages of speedometer and accelerometer which typically gives data at 10 Hz, to give the vehicle position at 10 Hz frequency. This results in improved collision detection capability of the system relative to a conventional detection system. Further, using V2V communication for transmitting a DGPS correction factor makes the system redundant, more robust and reliable compared to a system which uses a central station to broadcast the DGPS correction data. Additionally, use of a second Kalman Filter to modify the results of the first Kalman Filter prediction results in a system that is less sensitive to sensor noise and prediction errors. The reduction in sensitivity to sensor noise is because the second Kalman Filter modifies the results of the first Kalman filter using the information from the GIS system. In conventional systems, any vehicle position errors would get propagated through each prediction, making each subsequent future prediction less reliable.

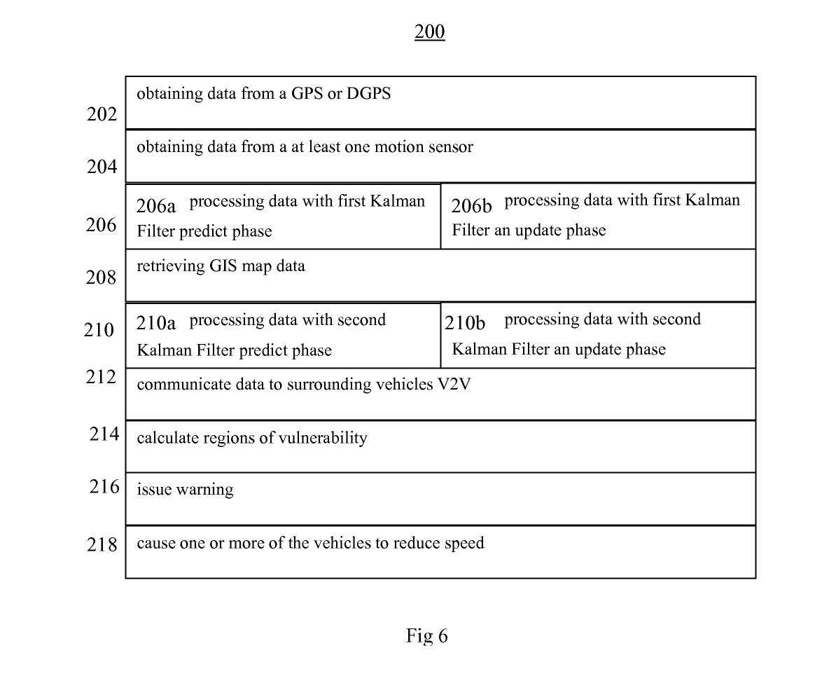

FIG. 5 is a flow diagram illustrating one embodiment of the above described methods. Method 100 comprises obtaining data from a global positioning system (GPS) device (or DGPS device) 102, obtaining data from a geographic information system (GIS) device 104, and obtaining data from a at least one motion sensor 106. The method also includes determining a position of a vehicle containing the GPS device, the GIS device, and the at least one motion sensor 108.

FIG. 6 is a flow diagram illustrating another embodiment of the above described methods. Method 200 includes obtaining data from a GPS or DGPS 202 and obtaining data from a at least one motion sensor 204. Next the GPS/DGPS and motion sensor data are processed with a first Kalman Filter 206 having a predict phase 206a and an update phase 206b. The GPS/DGPS and motion sensor data are fused with the Kalman Filter. Then GIS map data of the surround area is retrieved 208. The GIS data is processed with the fused GPS/DGPS and motion sensor data with a second Kalman Filter 210 which also may include a predict phase 210a and an update phase 210b.

The data may then be communicated to surrounding vehicles via vehicle-to-vehicle communications 212. Additionally, regions of vulnerability may be calculated around each of the participating vehicles 214. Should the system 200 detect the possibility of a collision, a warning may be issued to the vehicles at risk 216. Should the warning be ignored, the system 200 may cause one or more of the vehicles to reduce speed 218.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A system comprising:
a global positioning system (GPS) device;
at least one motion sensor;
a geographic information system (GIS) device; and
a measurement device,
wherein the measurement device obtains data from the GPS device, the GIS device, and the at least one motion sensor to determine a position of a vehicle containing the GPS device and the at least one motion sensor.

2. The system of claim 1, wherein the motion sensor is a speedometer or an accelerometer.

3. The system of claim 1, wherein the system is configured to provide collision warning and/or collision avoidance.

4. The system of claim 1, wherein the measurement device comprises at least one of a Fuzzy Logic, Kalman Filter, Adaptive Neural Network Measurement device, Genetic Algorithm, Particle Measurement device or Swarm Measurement device.

5. The system of claim 1, wherein the measurement device estimates the state of a linear dynamic system from a series of noisy measurements.

6. The system of claim 1, comprising a plurality of vehicles having a global position system device, at least one motion sensor, and a measurement device.

7. The system of claim 6, further comprising a vehicle to vehicle communications system.

8. The system of claim 1, further comprising a differential global positioning system device (DGPS).

9. The system of claim 1, further comprising a second measurement device.

10. The system of claim 1, wherein the geographic information system device comprises a map of the location of the vehicle.

11. The system of claim 10, wherein the measurement device is configured to use the map to make one or more future predictions of the potion and/or motion of the vehicle.

12. A method of providing collision warning and/or collision avoidance comprising:
obtaining data from a global positioning system (GPS) device, geographic information system (GIS) device, and at least one motion sensor; and
determining a position of a vehicle containing the GPS device, the GIS device, and the at least one motion sensor.

13. The method of claim 12, wherein determining a position comprises using one or more of a Fuzzy Logic, Kalman Filter, Adaptive Neural Network Measurement device, Genetic Algorithm, Particle Measurement device or Swarm Measurement device.

14. The method of claim 12, further comprising determining a region of vulnerability around the vehicle.

15. The method of claim 12, further comprising communicating with other vehicles.

16. The method of claim 12, further comprising slowing down at least one of a plurality of vehicles.

17. The method of claim 12, further comprising issuing a warning to a driver of the vehicle.

18. The method of claim 12, wherein determining the position of a vehicle comprises using a differential global positioning system.

19. The method of claim 12, wherein determining the position of a vehicle comprises using a map of the location of the vehicle.

20. The method of claim 12, further comprising determining an estimated future position of the vehicle based on present GPS, motion, and GIS data.
